(19) United States
(12) Patent Application Publication
(10) Pub. No.: US 2025/0299512 A1
(43) Pub. Date: Sep. 25, 2025

(54) SENSOR-BASED SMART INSECT MONITORING SYSTEM IN THE WILD

(71) Applicants: BOARD OF TRUSTEES OF THE UNIVERSITY OF ARKANSAS, Fayetteville, AR (US); SolaRid, LLC, Denver, CO (US)

(72) Inventors: Thanh-Dat Truong, Fayetteville, AR (US); Khoa Luu, Fayetteville, AR (US); Ashley Dowling, Fayetteville, AR (US); Randy J. Sasaki, Denver, CO (US)

(73) Assignees: BOARD OF TRUSTEES OF THE UNIVERSITY OF ARKANSAS, Fayetteville, AR (US); SolaRid, LLC, Denver, CO (US)

(21) Appl. No.: 18/863,553

(22) PCT Filed: May 8, 2023
(86) PCT No.: PCT/US2023/021330

§ 371 Date: Nov. 6, 2024

Related U.S. Application Data
(60) Provisional application No. 63/339,298, filed on May 6, 2022.

(51) Int. Cl. G06V 40/10; A01M 1/02; A01M 1/04; G06V 10/141; G06V 10/82; G06V 40/20

(52) U.S. Cl. CPC G06V 40/10; A01M 1/026; A01M 1/04; G06V 10/141; G06V 10/82; G06V 40/20; A01M 2200/01

(57) ABSTRACT

Embodiments of the present disclosure pertain to a computer-implemented method of insect monitoring by capturing at least one image of one or more insects; transmitting the at least one image to a computing device, where the computing device includes an artificial intelligence model operable to identify insects, and where the artificial intelligence model is trained on previously collected insect images via an unsupervised domain adaptation technique; and utilizing the artificial intelligence model to generate insect data related to the one or more insects from the at least one image. Additional embodiments of the present disclosure pertain to a system for insect monitoring.

### CROSS-REFERENCE TO RELATED APPLICATIONS

The present application claims the benefit of U.S. Provisional Patent Application No. 63/339,298, filed on May 6, 2022. The entirety of the aforementioned application is incorporated herein by reference.

### BACKGROUND

Crop yield management involves careful control of multiple factors, such as soil chemistry, water availability, plant spacing, weeds, and insect pests. Insect pest monitoring plays an important role in controlling the yield and quality of crops. However, insect monitoring is typically manual. Many hours of labor per acre are usually required to detect and recognize insects.

### SUMMARY

In some embodiments, the present disclosure pertains to a computer-implemented method of insect monitoring. In some embodiments, the method of the present disclosure includes: capturing at least one image of one or more insects; transmitting the at least one image to a computing device, where the computing device includes an artificial intelligence model operable to identify insects, and where the artificial intelligence model is trained on previously collected insect images via an unsupervised domain adaptation technique; and utilizing the artificial intelligence model to generate insect data related to the one or more insects from the at least one image. In some embodiments, the method of the present disclosure also includes a step of recommending a course of action and/or implementing a course of action based on the insect data.

Additional embodiments of the present disclosure pertain to a system for insect monitoring. In some embodiments, the system of the present disclosure is suitable for monitoring insects in accordance with the method of the present disclosure. In some embodiments, the system of the present disclosure includes one or more cameras operable to perform image capture in an insect imaging zone. The system of the present disclosure also includes a motion sensor communicably coupled to one or more cameras and operable to signal the one or more cameras to initiate image capture in response to detection of insect movement into the insect imaging zone.

Additionally, the system of the present disclosure includes a computing device with an artificial intelligence model operable to identify insects. The computing device is communicably coupled to one or more cameras and operable to receive at least one image of one or more insects from the one or more cameras and analyze the insect via the artificial intelligence model.

### BRIEF DESCRIPTION OF THE DRAWINGS

FIG. 1A illustrates a computer-implemented method of insect monitoring in accordance with various embodiments of the present disclosure.

FIG. 1B illustrates an example of a system for monitoring insects in accordance with various embodiments of the present disclosure.

FIG. 1C illustrates another example of a system for monitoring insects in accordance with various embodiments of the present disclosure.

FIG. 1D illustrates an example of a computing device for insect monitoring in accordance with various embodiments of the present disclosure.

FIG. 2 illustrates an example of a sliced Gromov-Wasserstein distance.

FIGS. 3A-3C illustrate an example of an algorithm training process.

FIGS. 4A-4B illustrate the operation of SolarID, an artificial intelligence-based system for monitoring insects.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Insect monitoring is one of the important factors in crop management and precision agriculture. Detection and identification of insects plays an important role in control and management of insect pests. However, manually monitoring insects is an extremely labor-intensive task, especially in large-scale farming operations. In particular, monitoring insects requires many hours of labor per acre to detect and recognize insects. Manually managing the insects could be impossible if it scales up to a large-scale farm.

Therefore, the ability to automatically detect and identify insects has become a primary demand in crop management. A highly adaptable insect trapping system and method that can automatically detect and identify a large variety of insects can be important in precision agriculture. Numerous embodiments of the present disclosure aim to address the aforementioned need.

### Methods of Insect Monitoring

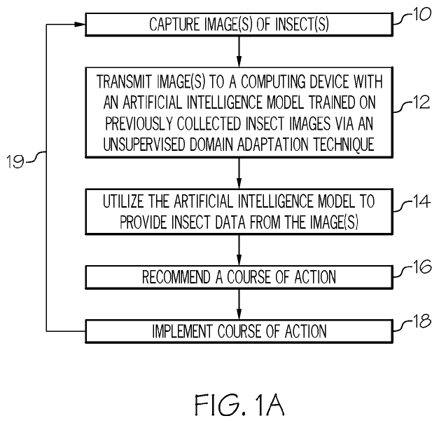

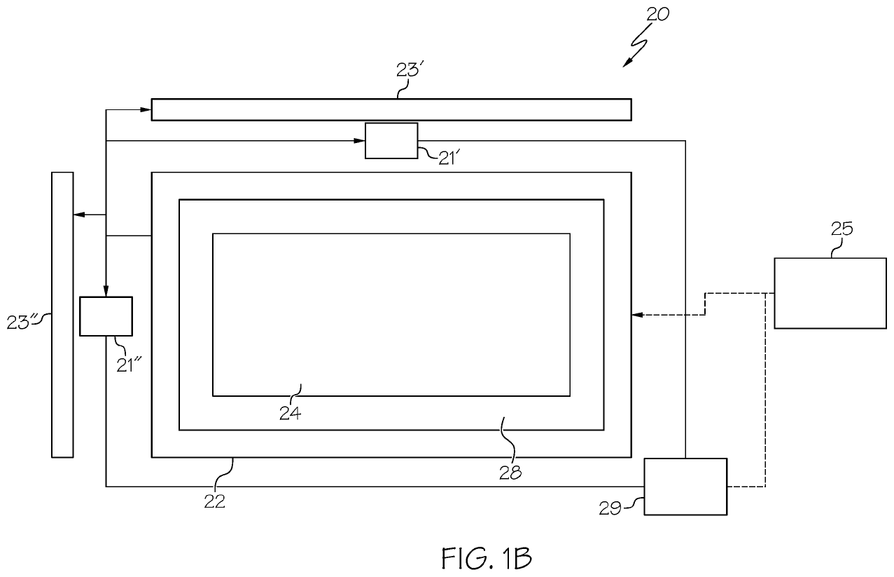

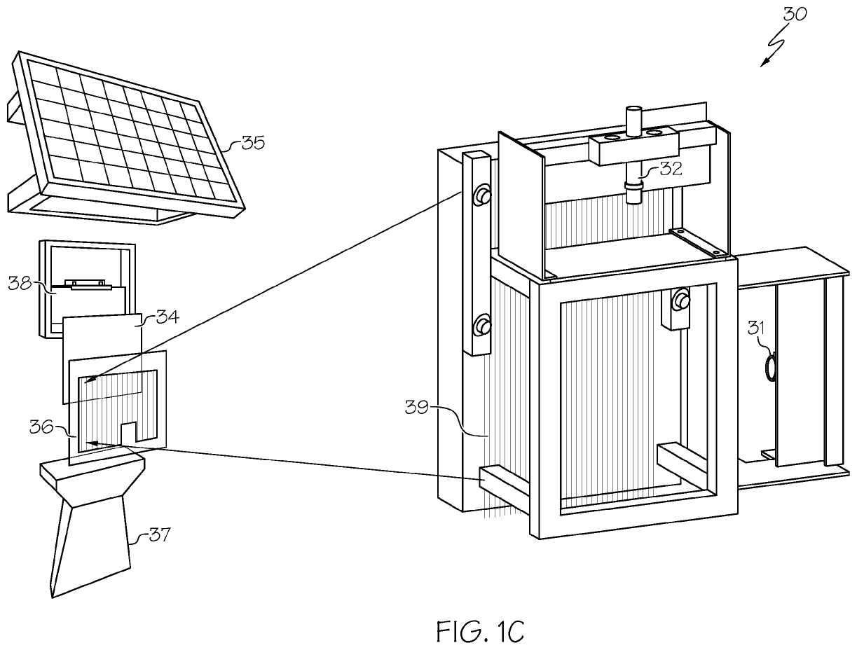

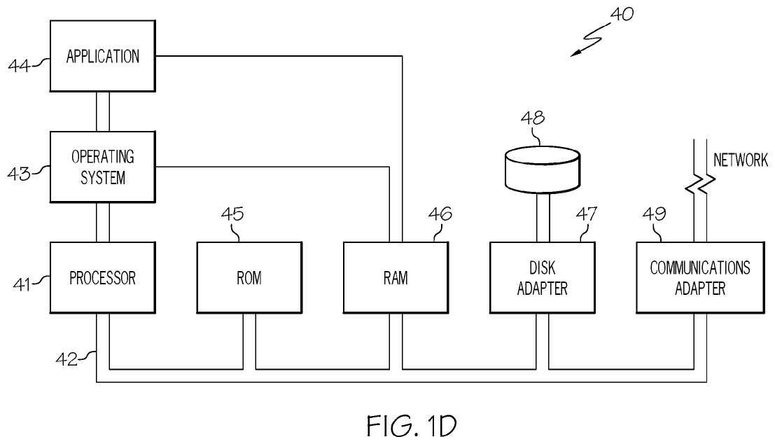

In some embodiments, the present disclosure pertains to a computer-implemented method of insect monitoring. In some embodiments illustrated in FIG. 1A, the method of the present disclosure includes: capturing at least one image of one or more insects (step 10); transmitting the at least one image to a computing device, where the computing device includes an artificial intelligence model operable to identify insects, and where the artificial intelligence model is trained on previously collected insect images via an unsupervised domain adaptation technique (step 12); and utilizing the artificial intelligence model to generate insect data related to the one or more insects from the at least one image (step 14). In some embodiments, the method of the present disclosure also includes a step of recommending a course of action based on the insect data (step 16). In some embodiments, the method of the present disclosure also includes a step of implementing a course of action based on the insect data (step 18). In some embodiments, the method of the present disclosure also includes a step of repeating the method after implementing the course of action (step 19).

In some embodiments, the capturing of at least one image occurs through the utilization of one or more cameras. In some embodiments, the method of the present disclosure also includes a step of detecting insect movement prior to capturing at least one image of one or more insects. In some embodiments, insect detection occurs during insect migration into an insect imaging zone.

In some embodiments, insect detection occurs by a motion sensor. In some embodiments, the capturing of at least one image occurs after the motion sensor detects insect movement and signals one or more cameras to initiate the capturing of images in response to the detected insect movement. In some embodiments, one or more cameras capture at least one image in an insect imaging zone in response to the signaling.

In some embodiments, one or more cameras include a first camera positioned to capture a top view of insects and a second camera positioned to capture a lateral view of insects. In some embodiments, at least one image includes a top-view image captured by the first camera and a lateral-view image captured by the second camera.

In some embodiments, the capturing of at least one image occurs automatically. In some embodiments, the capturing of at least one image occurs continuously.

In some embodiments, one or more cameras transmit at least one captured image to a computing device for processing. In some embodiments, the computing device is a portable computer. In some embodiments, the computing device stores the artificial intelligence model.

### Artificial Intelligence Models

The computing devices of the present disclosure may include various artificial intelligence models. For instance, in some embodiments, the artificial intelligence model is operable to identify insects.

In some embodiments, the artificial intelligence model includes a deep convolutional neural network. In some embodiments, the artificial intelligence model is operable to count and identify insects in real time.

In some embodiments, the artificial intelligence model is operable to differentiate between different types of insects. For instance, in some embodiments, the artificial intelligence model is operable to differentiate between insects to be eliminated and insects to be preserved.

In some embodiments, the artificial intelligence model is operable to recognize new types of insects that were not part of a training dataset. In some embodiments, the new types of insects include new population-level variations of insects. In some embodiments, the new types of insects include new species of insects.

In some embodiments, the artificial intelligence model is trained on previously collected insect images via an unsupervised domain adaptation technique. In some embodiments, the unsupervised domain adaptation technique for training the artificial intelligence model includes: (1) training the artificial intelligence model and a classifier on a source dataset in a source domain; and (2) adapting knowledge learned on the source domain to a target domain via unsupervised domain adaptive training. In some embodiments, the unsupervised adaptive training includes: (a) projecting features that are on at least two domains into one-dimensional space; (b) computing a plurality of Gromov-Wasserstein distances on the one-dimensional space, and determining a sliced Gromov-Wasserstein distance based at least partly on an average of the plurality of Gromov-Wasserstein distances; and (c) deploying the artificial intelligence model in the target domain in response to the adapting.

In some embodiments, the determined Gromov-Wasserstein distance aligns and associates features between the source domain and the target domain. In some embodiments, the alignment reduces topological differences of feature distributions between the source domain and the target domain. In some embodiments, the unsupervised domain adaptation technique for training the artificial intelligence model includes training the artificial intelligence model on labeled data from the source domain to achieve better performance on data from the target domain with access to only unlabeled data in the target domain.

In some embodiments, the classifier is a convolutional neural network (CNN) algorithm. In some embodiments, the CNN algorithm includes, without limitation, Region-based CNN (R-CNN) algorithms, Fast R-CNN algorithms, rotated CNN algorithms, mask CNN algorithms, and combinations thereof.

In some embodiments, the source dataset includes labeled data. In some embodiments, the source dataset includes data on pre-defined insects. In some embodiments, the source dataset includes data on different types of insects. In some embodiments, the different types of insects include population-level variations of insects, different species of insects, or combinations thereof. In some embodiments, the source dataset includes images of the different types of insects.

In some embodiments, the source domain includes data distribution from the source dataset on which the model is trained. In some embodiments, the target domain includes data distribution on which the artificial intelligence model pre-trained on the source dataset in the source domain is used to perform a similar task.

### Insect Data

The artificial intelligence models of the present disclosure may be utilized to generate various types of insect data. For instance, in some embodiments, the insect data includes the identity of one or more insects, the number of one or more insects, the gender of the one or more insects, or combinations thereof.

In some embodiments, the insect data includes the identity of one or more insects. In some embodiments, the identity of one or more insects includes a classification of the one or more insects. In some embodiments, the classification is based on population-level variation of one or more insects. In some embodiments, the classification is based on the species of one or more insects.

Recommending and/or Implementing a Course of Action

In some embodiments, the method of the present disclosure also includes a step of recommending and/or implementing a course of action based on the generated insect data. For instance, in some embodiments, the course of action includes fumigation, extermination, insect capturing, insect elimination, insect preservation, release of insect repellants, release of insect mating disruption pheromones, or combinations thereof. In some embodiments, the course of action includes extermination. In some embodiments, the extermination is implemented by activation of a killing grid system. In some embodiments, the method of the present disclosure is repeated after implementing the course of action.

### Systems for Insect Monitoring

Additional embodiments of the present disclosure pertain to a system for insect monitoring. In some embodiments, the system of the present disclosure is suitable for monitoring insects in accordance with the method of the present disclosure. FIG. 1B provides an example of a system of the present disclosure as system 20 for illustrative purposes. System 20 includes one or more cameras 21 operable to perform image capture in an insect imaging zone 28. System 20 also includes a motion sensor 22 communicably coupled to one or more cameras 21 and operable to signal the one or more cameras to initiate image capture in response to detection of insect movement into the insect imaging zone 28. In some embodiments, the motion sensor is a laser sensor. In some embodiments, the motion sensor is a SICK Switching Automation Light Grids FLG.

The system of the present disclosure can include various arrangements of one or more cameras. For instance, in some embodiments illustrated in FIG. 1B, one or more cameras 21 include a first camera 21′ positioned to capture a top view of insects, and a second camera 21″ positioned to capture a lateral view of insects. In some embodiments, a captured image includes a top-view image captured by the first camera 21′ and a lateral-view image captured by the second camera 21″.

The system of the present disclosure can include various types of cameras. For instance, in some embodiments, the one or more cameras include one or more red, green and blue wavelengths (RGB) cameras. In some embodiments, the one or more cameras include one or more UV cameras. In some embodiments, the one or more cameras include one or more FLIR Blackfly S cameras.

Additionally, system 20 includes computing device 29 communicably coupled to the one or more cameras 21. In some embodiments, the computing device can include a portable computer, such as an NVIDIA Jetson AGX Xavier.

Computing device 29 includes an artificial intelligence model operable to identify insects. Computing device 29 is operable to receive at least one image of one or more insects from the one or more cameras 21 and analyze the insect via the artificial intelligence model.

Computing device 29 may include various artificial intelligence models. Suitable artificial intelligence models were described supra and are incorporated herein by reference. For in some embodiments, the artificial intelligence model is trained on previously collected insect images via an unsupervised domain adaptation technique.

In some embodiments, the system of the present disclosure includes a lighting system. In some embodiments, the lighting system includes one or more lights. In some embodiments, the one or more lights include light-emitting diodes (LEDs).

In some embodiments illustrated in FIG. 1B, the lighting system includes lights 23′ and 23″. In some embodiments, cameras 21′ and 21″ and lights 23′ and 23″ are timed via a hardware trigger such that cameras 21′ and 21″ capture at least one image at approximately the same time as lights 23′ and 23″ flash.

In some embodiments, the system of the present disclosure also includes an insect attracting system. In some embodiments illustrated in FIG. 1B, the insect attracting system includes a light trap 24. In some embodiments, the insect attracting system also includes one or more semiochemicals to attract insects.

In some embodiments, the system of the present disclosure also includes a power supply that is operable to provide energy to the system. In some embodiments illustrated in FIG. 1B, system 20 includes a power supply 25 that is operable to provide energy to system 20. In some embodiments, the power supply is solar powered. In some embodiments, the power supply is a solar panel.

In some embodiments, the system of the present disclosure also includes a dispenser that includes one or more chemicals. In some embodiments, the dispenser is in electrical communication with a computing device and operable to dispense the one or more chemicals upon receiving instructions from the computing device. In some embodiments, the one or more chemicals include, without limitation, fumigators, exterminators, insect repellants, insect mating disruption hormones, or combinations thereof.

The system of the present disclosure may be operated in various manners. For instance, in some embodiments illustrated in FIG. 1B, insects migrate into light trap 24 near an insect imaging zone 28. Thereafter, motion sensor 22 detects insect movement into the insect imaging zone 28. Next, cameras 21′ and 22″ initiate image capture in response to detection of insect movement into the insect imaging zone 28 at approximately the same time as lights 23′ and 23″ flash. In particular, first camera 21′ captures a top view of insects while second camera 21″ captures a lateral view of insects. Thereafter, cameras 21′ and 22″ transmit the captured images to computing device 29, which then analyzes the insects via the artificial intelligence model in the computing device.

The system of the present disclosure can include various components and arrangements. For instance, FIG. 1C illustrates an example of another system of the present disclosure as system 30 for illustrative purposes. System 30 includes camera 31 operable to perform image capture in an insect imaging zone 39. System 30 also includes a motion sensor 32 communicably coupled to camera 31 and operable to signal camera 31 to initiate image capture in response to detection of insect movement into the insect imaging zone 39.

System 30 also includes a light trap 34 and semiochemicals 38 for attracting insects to insect imaging zone 39. Additionally, system 30 includes power supply 35, which is a solar panel. System 30 also includes a killing grid system 36 for killing the insects, and a receptor bag 37 for collecting the killed insects.

In operation, insects migrate into light trap 34 near insect imaging zone 39. Thereafter, motion sensor 32 detects insect movement into insect imaging zone 39. Next, camera 31 initiates image capture in response to detection of insect movement into the insect imaging zone. Thereafter, camera 31 transmits the captured images to a computing device, which then analyzes the insects via an artificial intelligence model in the computing device.

### Computing Devices

The computing devices of the present disclosure can include various types of computer readable storage mediums. For instance, in some embodiments, the computer readable storage mediums can be a tangible device that can retain and store instructions for use by an instruction execution device. In some embodiments, the computer readable storage medium may include, without limitation, an electronic storage device, a magnetic storage device, an optical storage device, an electromagnetic storage device, a semiconductor storage device, or combinations thereof. A non-exhaustive list of more specific examples of suitable computer readable storage medium includes, without limitation, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, or combinations thereof.

A computer readable storage medium, as used herein, is not to be construed as being transitory signals per se. Such transitory signals may be represented by radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions for computing devices can be downloaded to respective computing/processing devices from a computer readable storage medium or to an external computer or external storage device via a network, such as the Internet, a local area network, a wide area network and/or a wireless network. In some embodiments, the network may include copper transmission cables, optical transmission fibers, wireless transmission, routers, firewalls, switches, gateway computers and/or edge servers. In some embodiments, a network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages.

In some embodiments, the computer readable program instructions may execute entirely on the user's computer, partly on the user's computer, as a stand-alone software package, partly on the user's computer and partly on a remote computer or entirely on the remote computer or server. In the latter scenario, the remote computer may be connected in some embodiments to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present disclosure.

Embodiments of the present disclosure for insect monitoring as discussed herein may be implemented using a computing device illustrated in FIG. 1D. Referring now to FIG. 1D, FIG. 1D illustrates an embodiment of the present disclosure of the hardware configuration of a computing device 40 which is representative of a hardware environment for practicing various embodiments of the present disclosure.

Computing device 40 has a processor 41 connected to various other components by system bus 42. An operating system 43 runs on processor 41 and provides control and coordinates the functions of the various components of FIG. 1D. An application 44 in accordance with the principles of the present disclosure runs in conjunction with operating system 43 and provides calls to operating system 43, where the calls implement the various functions or services to be performed by application 44. Application 44 may include, for example, a program for insect control as discussed in the present disclosure, such as in connection with FIGS. 1A-1C, 2, 3A-3C, and 4A-4B.

Referring again to FIG. 1D, read-only memory (“ROM”) 45 is connected to system bus 42 and includes a basic input/output system (“BIOS”) that controls certain basic functions of computing device 40. Random access memory (“RAM”) 46 and disk adapter 47 are also connected to system bus 42. It should be noted that software components including operating system 43 and application 44 may be loaded into RAM 46, which may be computing device's 40 main memory for execution. Disk adapter 47 may be an integrated drive electronics (“IDE”) adapter that communicates with a disk unit 48 (e.g., a disk drive). It is noted that the program for insect control, as discussed in the present disclosure, such as in connection with FIGS. 1A-1C, 2, 3A-3C, and 4A-4B may reside in disk unit 48 or in application 44.

Computing device 40 may further include a communications adapter 49 connected to bus 42. Communications adapter 49 interconnects bus 42 with an outside network (e.g., wide area network) to communicate with other devices.

Aspects of the present invention are described herein with reference to flowchart illustrations and/or block diagrams of methods, apparatus (systems), and computing devices according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Applications and Advantages

In various embodiments, the system and method described herein can achieve various advantages. In an example, the system provides better image quality, is compact, and is highly portable such that it is easy to deploy in remote areas using solar power. In various embodiments, the principles described in the present disclosure are applicable to multiple fields such as, for example, pest control and/or identifying bugs essential for protecting farms. More generally, the principles described herein can be widely applicable in agriculture. In addition, in some embodiments, the proposed hardware design is a complete unit that can be deployed in any farm or any region or country.

In some embodiments, the disclosed hardware provides a better quality of captured images compared to commercial webcams and cameras. Additionally, the method and system of the present disclosure uses an adaptable artificial intelligence algorithm so that it performs well on the new species.

In some embodiments, the entire system of the present disclosure is designed as a compact module powered by solar energy. Therefore, in some embodiments, the system of the present disclosure is highly portable and can be deployed in any region.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Artificial Intelligence Model for Insect Control in a Realtime Environment

This Example describes a new deep learning-based domain adaptation algorithm by utilizing sliced Gromov-Wasserstein distance. By minimizing the gap of distributions between different datasets, the proposed method can generalize well on the new target domains. In addition, this Example describes a hardware system for deploying the deep learning model, as a complete system, to run in real-world farms. Additionally, this Example describes deep learning approaches to train a robust insect classifier.

In addition, this Example presents a framework for unsupervised domain adaptation based on optimal transport-based distance to train the robust insect classifier. The framework introduces an optimal transport-based distance named Gromov-Wasserstein for unsupervised domain adaptation. The presented Gromov-Wasserstein distance can help to align and associate features between source and target domains. The alignment process can help to mitigate the topological differences of feature distributions between two different domains. This Example also presents a sliced approach to fast approximate the Gromov-Wasserstein distance.

This Example also utilizes recent advanced deep learning approaches to deal with limited training samples. In particular, Applicant presents a novel optimal transport loss approach to domain adaptation integrated into the deep CNN to train a robust insect classifier.

The most recent domain adaptation methods are based on adversarial training that minimizes the discrepancy between source and target domains. However, minimizing feature distributions in different domains is not practical due to the lack of a feasible metric across domains. Moreover, these current methods ignore the feature structures between source and target domains. To address these issues, this Example proposes a novel optimal transport distance, specifically, the Gromov-Wasserstein distance, that allows comparing features across domains while aligning feature distributions and maintaining the feature structures between source and target domains. In addition, since the computation of Gromov-Wasserstein distance is costly due to the solving non-convex quadratic assignment problem, this Example presents a fast approximation form of Gromov-Wasserstein distance based on 1D-Gromov-Wasserstein distance.

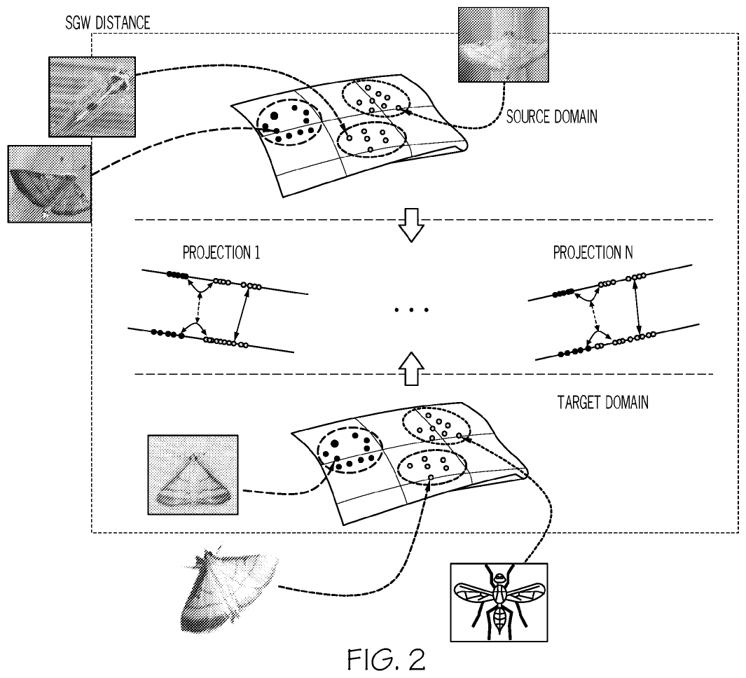

As shown in FIG. 2, the high dimensional features on two domains are projected into one-dimensional space. Then, the Gromov-Wasserstein distance on the 1D space is efficiently computed. Finally, the sliced Gromov-Wasserstein distance will be the average of the Gromov-Wasserstein distances on the 1D space via multiple projections.

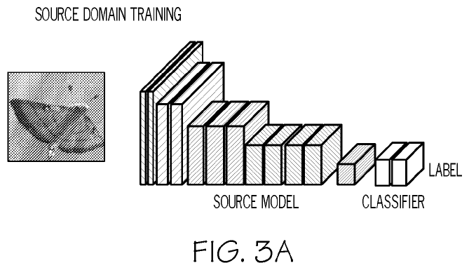

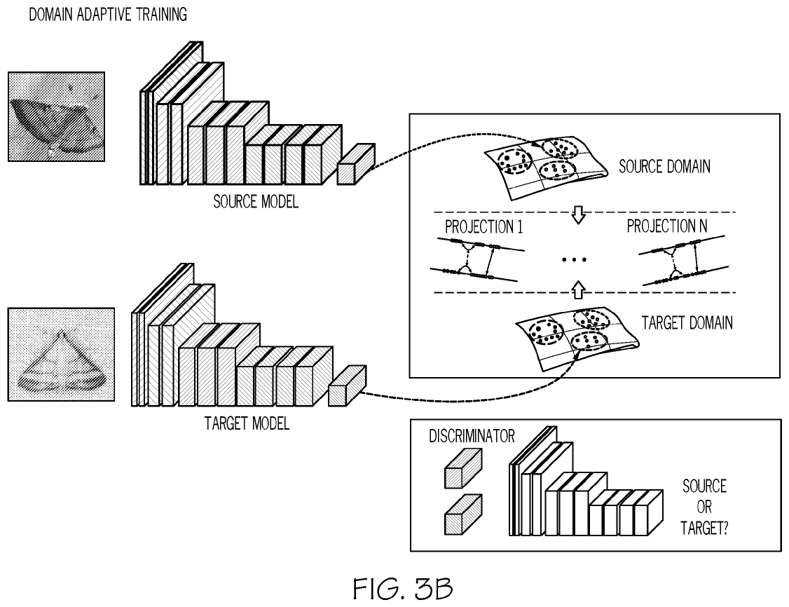

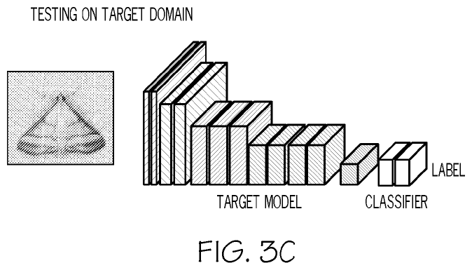

As shown in FIGS. 3A-3C, the training process involves two main steps. First, the source model and the classifier are trained on source datasets (FIG. 3A). Then, the knowledge learned on the source domain is adapted to the target domain during domain adaptive training process (FIG. 3B). Finally, the final model is deployed into the target domain (FIG. 3C).

### Example 2. SolarID: An Artificial Intelligence Model for Effective Insect Control

Each spring, producers in the almond industry hire 3,000 Pest Control Advisors (PCA) to monitor 1.5 million acres of orchards. In March, they began monitoring growth stages, rainfall, and ambient temperatures in their clients' orchards to develop routes and schedules of monitoring frequency. PCAs' lives during the growing season are a race that involves driving hundreds of miles to and from client locations, monitoring thousands of acres each week and balancing time and expenditures.

The current (legacy approach) to integrated pest management (IPM) strategies require PCAs to hang one disposable pheromone trap per 10 acres—seven feet high in trees. These traps contain a replaceable adhesive surface to attract male species. Most strategies use egg traps containing kairomones to attract female species to deposit eggs on the trap.

PCAs spend 5-6 hours each day hand-counting the number of eggs deposited and/or identifying and counting many dozens of different species of insects. Pest control advisors analyze rising levels of infestation to recommend the optimum timing of responses measured against economic threshold levels; but balance the increasing expense from 5-to-7 insecticide applications per season to the annual budget. This is a key element of monitoring, as population levels of each of the 5 generations can grow 1,800%, increasing damage to crops exponentially through the season.

The expense of insecticides and labor for applications averages $118/acre and disposable traps also require service to replace adhesive surfaces biweekly and attractants every 40-days. The average expense to apply, monitor and service these labor-intensive disposable devices is high (e.g., $140/acre). Additionally, with this type of manual monitoring, the results are not consistent or accurate.

The system must be duplicated to monitor other targeted species of insects. Another primary need cited by farmers and pest control advisors during customer discovery interviews concerned mating disruption (MD). When adjacent farms do not use MD technology or other similarly effective controls, insects cross-over to unprotected farms. Additionally, females impregnated at a different location will migrate and lay eggs at unsuspecting-protected farms. Both situations lead to damaged crops before a response can be implemented. As a result, producers currently have to use pest control advisors to monitor the effectiveness of MD technology.

In this Example, the artificial intelligence (AI) model described in Example 1 is deployed as a platform to develop an unmatched precision agriculture monitoring system that is referred to herein as SolarID. SolarID is comprehensive and adaptable with a simplified application due to automation of artificial intelligence monitoring its ability to report pest infestations in real-time, enabling precise responses that reduce expense, infestations, and losses.

SolarID recommends a targeted chemical insecticide application to knock-down the first critical overwintering insect population. During the following infestations, SolarID recommends a synthetic pheromone response, released from mating disruption (MD) dispensers to be controlled by the SolarID insect control device (ICD). This new alternative to chemical insecticides does not have to contact insects; it is a preventative method that keeps males from locating females to reduce infestations without toxic chemicals. In the fall, the solar-powered system continues to operate post-harvest to measure over-wintering populations of targeted species of insects. Because the AI technology is designed to continually learn new species, the system adapts to monitor different species of insects found in different global geographic areas.

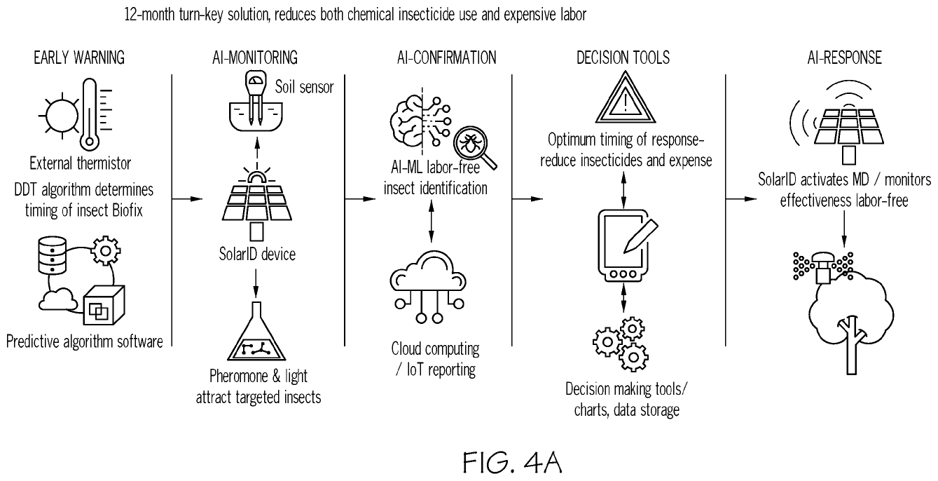

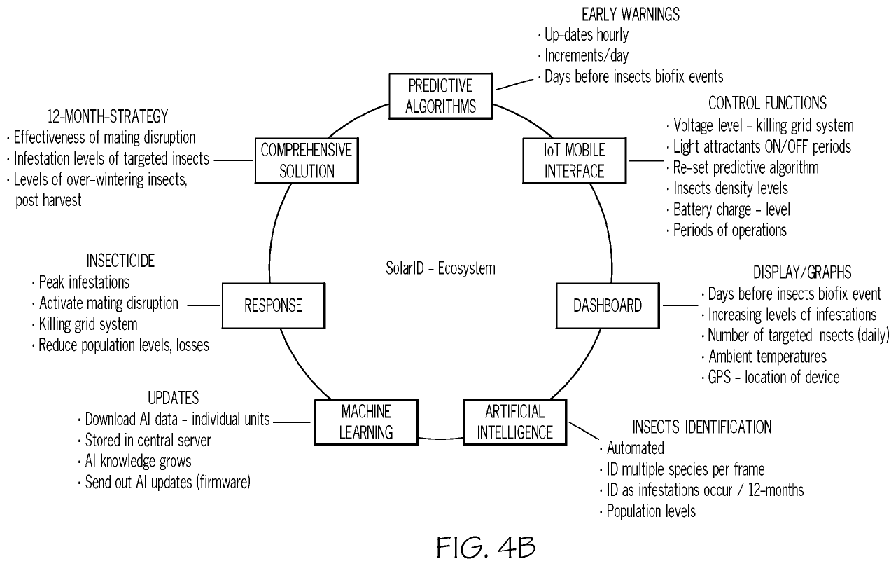

An innovative aspect of SolarID is the exclusive capability of AI used during cultivation of crops to identify damaging species of insects and automatically enable timely responses, reducing labor and losses. SolarID also enables a comprehensive turn-key solution (illustrated in FIGS. 4A-4B) that integrates a response to complete a 12-month strategy and ensure overall effectiveness. With a response to insects' infestations detected by AI, integrated with a mating disruption (MD) technology, the result is an effective pest management system. This exclusive capability enables SolarID to replace multiple commercial products used for different crop types and others for identification of insect species and sex in one device.

### Example 2.1. Commercial Impact of SolarID

A system that can identify a broad diversity of insects and continue to learn new identifications and refine existing species concepts can revolutionize ecological studies on arthropods, greatly increase the speed and accuracy of insect diagnostics work around the country and can be used for biomonitoring to assess water quality. As the AI technology learns a broader identification of insects, an objective of the AI technology application is to create regional-municipal, state and/or national interconnected-networks of SolarID monitoring and aggregating data. The objective of establishing these networks is to create an early warning system, predict migration patterns and to identify the presence of invasive and infectious species of insects.

The knowledge to be gained through these networks represents a substantial benefit to the American public by potentially reducing use of pesticides and having higher crop yield using the same natural resources. The application of SolarID has the potential to reduce crop loss by more than $5 billion annually and reduce the $100 billion of expense caused by invasive species and $7 billion of health expense from infectious insects by early detection of presence of species of dangerous insects.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A computer-implemented method of insect monitoring, said method comprising:
capturing at least one image of one or more insects;
transmitting the at least one image to a computing device,
wherein the computing device comprises an artificial intelligence model operable to identify insects,
wherein the artificial intelligence model is trained on previously collected insect images via an unsupervised domain adaptation technique; and
utilizing the artificial intelligence model to generate insect data related to the one or more insects from the at least one image.

2. The method of claim 1, further comprising a step of detecting insect movement prior to capturing the at least one image of the one or more insects.

3. The method of claim 2, wherein the detecting occurs during insect migration into an insect imaging zone.

4. The method of claim 3, wherein the detecting occurs by a motion sensor.

5. The method of claim 4, wherein the capturing of the at least one image occurs after the motion sensor detects insect movement and signals one or more cameras to initiate the capturing of images in response to the detected insect movement, and wherein the one or more cameras capture at least one image in the insect imaging zone in response to the signaling.

6. The method of claim 5, wherein the one or more cameras comprise a first camera positioned to capture a top view of insects and a second camera positioned to capture a lateral view of insects; and wherein the at least one image comprises a top-view image captured by the first camera and a lateral-view image captured by the second camera.

7. The method of claim 5, wherein the one or more cameras transmit the at least one image to the computing device for processing.

8. The method of claim 1, wherein the unsupervised domain adaptation technique for training the artificial intelligence model comprises:
training the artificial intelligence model and a classifier on a source dataset in a source domain;
adapting knowledge learned on the source domain to a target domain via unsupervised domain adaptive training, wherein the unsupervised adaptive training comprises:
projecting features that are on at least two domains into one-dimensional space;
computing a plurality of Gromov-Wasserstein distances on the one-dimensional space, and determining a sliced Gromov-Wasserstein distance based at least partly on an average of the plurality of Gromov-Wasserstein distances; and
deploying the artificial intelligence model in the target domain in response to the adapting.

9. The method of claim 8, wherein the determined Gromov-Wasserstein distance aligns and associates features between the source domain and the target domain.

10. The method of claim 8, wherein the alignment reduces topological differences of feature distributions between the source domain and the target domain.

11. The method of claim 8, wherein the unsupervised domain adaptation technique for training the artificial intelligence model comprises training the artificial intelligence model on labeled data from the source domain to achieve better performance on data from the target domain with access to only unlabeled data in the target domain.

12. The method of claim 8, wherein the classifier is a convolutional neural network (CNN) algorithm.

13. The method of claim 12, wherein the CNN algorithm is selected from the group consisting of Region-based CNN (R-CNN) algorithms, Fast R-CNN algorithms, rotated CNN algorithms, mask CNN algorithms, and combinations thereof.

14. The method of claim 1, wherein the insect data comprises the identity of the one or more insects, the number of the one or more insects, the gender of the one or more insects, or combinations thereof.

15. The method of claim 1, wherein the insect data comprises the identity of the one or more insects.

16. The method of claim 15, wherein the identity of the one or more insects comprises a classification of the one or more insects,

17. The method of claim 16, wherein the classification is based on population-level variation of the one or more insects.

18. The method of claim 16, wherein the classification is based on the species of the one or more insects.

19. The method of claim 1, further comprising a step of recommending a course of action, implementing a course of action, or combinations thereof.

20. The method of claim 19, wherein the course of action comprises fumigation, extermination, insect capturing, insect elimination, insect preservation, release of insect repellants, release of insect mating disruption pheromones, or combinations thereof.

21. The method of claim 19, further comprising a step of repeating the method after implementing the course of action.

22. A system for monitoring insects comprising:
one or more cameras operable to perform image capture in an insect imaging zone;
a motion sensor communicably coupled to the one or more cameras and operable to signal the one or more cameras to initiate image capture in response to detection of insect movement into the insect imaging zone; and
a computing device communicably coupled to the one or more cameras,
wherein the computing device comprises an artificial intelligence model operable to identify insects,
wherein the artificial intelligence model is trained on previously collected insect images via an unsupervised domain adaptation technique, and
wherein the computing device is operable to receive at least one image of one or more insects from the one or more cameras and analyze the insect via the artificial intelligence model.

23. The system of claim 22, wherein the one or more cameras comprise a first camera positioned to capture a top view of insects and a second camera positioned to capture a lateral view of insects, and wherein the at least one image comprises a top-view image captured by the first camera and a lateral-view image captured by the second camera.

24. The system of claim 22, further comprising a lighting system.

25. The system of claim 24, wherein the lighting system comprises one or more lights, wherein the one or more cameras and the one or more lights are timed via a hardware trigger such that the one or more cameras capture the at least one image at approximately the same time as the one or more lights flash.

26. The system of claim 22, further comprising an insect attracting system.

27. The system of claim 26, wherein the insect attracting system comprises a light trap.

28. The system of claim 26, wherein the insect attracting system further comprises one or more semiochemicals to attract insects.

29. The system of claim 22, further comprising a power supply, wherein the power supply is operable to provide energy to the system.

30. The system of claim 22, wherein the unsupervised domain adaptation technique for training the artificial intelligence model comprises:
training the artificial intelligence model and a classifier on a source dataset in a source domain;
adapting knowledge learned on the source domain to a target domain via unsupervised domain adaptive training, wherein the unsupervised adaptive training comprises:
projecting features that are on at least two domains into one-dimensional space;
computing a plurality of Gromov-Wasserstein distances on the one-dimensional space, and determining a sliced Gromov-Wasserstein distance based at least partly on an average of the plurality of Gromov-Wasserstein distances; and
deploying the artificial intelligence model in the target domain in response to the adapting.

31. The system of claim 30, wherein the determined Gromov-Wasserstein distance aligns and associates features between the source domain and the target domain.

32. The system of claim 30, wherein the alignment reduces topological differences of feature distributions between the source domain and the target domain.

33. The system of claim 30, wherein the unsupervised domain adaptation technique for training the artificial intelligence model comprises training the artificial intelligence model on labeled data from the source domain to achieve better performance on data from the target domain with access to only unlabeled data in the target domain.

34. The system of claim 30, wherein the classifier is a convolutional neural network (CNN) algorithm.

35. The system of claim 34, wherein the CNN algorithm is selected from the group consisting of Region-based CNN (R-CNN) algorithms, Fast R-CNN algorithms, rotated CNN algorithms, mask CNN algorithms, and combinations thereof.

36. The system of claim 33, wherein the system further comprises a dispenser comprising one or more chemicals, wherein the dispenser is in electrical communication with the computing device and operable to dispense the one or more chemicals upon receiving instructions from the computing device.

37. The system of claim 36, wherein the one or more chemicals are selected from the group consisting of fumigators, exterminators, insect repellants, insect mating disruption hormones, or combinations thereof.
